(19) United States
(12) Patent Application Publication
(10) Pub. No.: US 2022/0248691 A1
(43) Pub. Date: Aug. 11, 2022

(54) BROAD-SPECTRUM HERBICIDE

(71) Applicant: Robins Arthur Maine Robins, Wicklow (IE)

(72) Inventor: Ronald Arthur Maine Robins, Wicklow (IE)

(21) Appl. No.: 17/626,068

(22) PCT Filed: Jul. 16, 2020
(86) PCT No.: PCT/EP2020/070144

§ 371 Date: Jan. 10, 2022

(30) Foreign Application Priority Data
Jul. 24, 2019 (GB) 1910569.1

(51) Int. Cl. A01N 65/06; A01N 65/30; A01N 37/04; A01N 65/20; A01N 65/40

(52) U.S. Cl. CPC A01N 65/06; A01N 65/30; A01P 13/02; A01N 65/20; A01N 65/40; A01N 37/04

(57) ABSTRACT

A systemic, broad-spectrum herbicide comprises a water-soluble extract of one or more plant parts of rhubarb and yew. The herbicide can also contain other plant material, including plant parts of Bryonia and Laburnum. The herbicide, which is based on natural products can translocate to the roots of a plant, when the herbicide is applied to an aerial part of the plant. The herbicide can eradicate grasses, mosses and weeds, including bindweed, nettles and dockweed.

This invention relates to a broad-spectrum herbicide and, in particular, to a non-synthetic, systemically acting broad-spectrum herbicide based on plant material.

Roundup is the brand name of a systemic broad-spectrum herbicide and crop desiccant originally produced by Monsanto and acquired by Bayer in 2018. The active ingredient of Roundup is the isopropylamine salt of glyphosate (N-(phosphonomethyl)glycine). Roundup is used for non-selective post-emergence weed control. As Roundup is a non-selective herbicide, it will kill most plants. It prevents plants from making certain proteins that are needed for plant growth. Glyphosate stops a specific enzyme pathway, the shikimic acid pathway, which is necessary for plants and some microorganisms. Specifically, glyphosate is an inhibitor of the enzyme 5-enolpyruvyl-shikimate-3-phosphate synthetase (EPSPS).

Glyphosate is applied to the leaves of plants to kill both broad leaf plants and grasses. As glyphosate is a broad-spectrum herbicide, it has negative effects on nearly every plant with which it comes in contact; it is used for spot treatment of grasses, lawns, paved areas and some agricultural crops.

Although, it is toxic, the active chemical of Roundup, glyphosate binds with soil, which implies that it becomes inactive and does not run off into water systems. However, if Roundup reaches rivers and streams it is very toxic to aquatic life.

There has been much controversy in recent years as regards the harmful effects of Roundup to humans and many legal actions have been taken against Monsanto by persons claiming to have developed various forms of cancer through their use of Roundup.

In recent times, the toxicity and environmental safety of glyphosate has been questioned.

Glyphosate has been classified as a probable carcinogen by the International Agency for Research on Cancer.

On the other hand, the US EPA (US Environmental Protection Agency) classifies glyphosate as a Group E chemical, which means that there is strong evidence that it does not cause cancer in humans.

Roundup also contains the surfactant polyethoxylated tallow amine (also polyoxyethyleneamine) (POEA), which is used to transport glyphosate from the leaves of a plant to the roots. This ingredient of Roundup is more toxic to aquatic life than glyphosate.

As of January 2019, the sale, distribution and use of Roundup 360 has been banned in France.

Monsanto also produced seeds which grow into plants genetically engineered to be tolerant to glyphosate, which are known as Roundup Ready crops. Such crops allow farmers to use glyphosate as a post-emergent herbicide against most broadleaf and cereal weeds.

Alternatives to the use of Roundup have been proposed, especially by those concerned by the use of Roundup on environmental grounds, such as organic farmers.

A number of alternative herbicides, based on natural products have been used.

One such product is vinegar.

Vinegar is natural, inexpensive and readily available. However, household vinegar is not strong enough to kill most weeds, while horticultural vinegar will burn many. In general, vinegar tends to burn the leaves of a plant, to which it is applied.

With vinegar use weeds grow back in a couple of weeks. Vinegar quickly breaks down in soil and water.

Other alternative herbicides include those based on fatty acids, often in the form of soaps. One such herbicide is pelargonic acid. In general, these fatty acid-based herbicides are only active for a short period of time.

Other alternative herbicides are based on essential plant oils, such as clove, peppermint, pine and citronella oils.

However, all of the above-mentioned alternative herbicides burn the leaves, but not the roots of a plant, unless a surfactant is added. These herbicides exhibit contact-type activity, namely they do not translocate to the roots of treated plants.

Thus, there is a need for a systemic herbicide based on natural products which can translocate to the roots of a plant, when the herbicide is applied to an aerial part of the plant.

Thus, the invention provides a systemic, broad-spectrum herbicide comprising a water-soluble extract of one or more plant parts of rhubarb and yew.

Preferably, the plant part of rhubarb is the leaves.

For maximum results, the rhubarb is harvested late summer to early autumn.

Preferably, the plant part of yew is a mixture of the bark and the foliage of the genus taxus.

Winter harvesting of the plant parts of yew is preferred, in particular in the case of the bark.

Further, preferably, the yew is common yew (Taxus baccata) or Japanese yew (Taxus cuspidata).

According to one embodiment of the invention, the herbicide contains one part rhubarb extract to two parts yew extract.

According to another embodiment of the invention, the herbicide further contains a water-soluble extract of one or more plant parts of the genus bryonia.

Preferably, the plant part is from Black Bryony (Dioscorea communis).

Preferably, the plant part is the roots and/or the berries of Black Bryony.

For maximum results, the Bryony is harvested in the autumn.

According to another embodiment of the invention, the herbicide further contains a water-soluble extract of one or more plant parts of the genus Fabaceae.

Preferably, the plant part is from common laburnum.

Preferably, the plant part is selected from the bark, leaves and/or pods and seeds of common laburnum.

In a further embodiment of the invention, the herbicide contains one part rhubarb extract to two parts yew extract, one part bryony extract and one part laburnum extract.

In a further embodiment of the invention, the rhubarb extract is supplemented with oxalic acid, when the concentration thereof is low in the leaves due to seasonal variation.

Preferably, the herbicide is applied topically to plants which are to be eradicated.

Further, preferably, the herbicide is applied by immersion, painting or spraying to an aerial part of a plant to be eradicated.

The herbicide according to the invention has been found to be particularly effective against bindweed (convolvulus) grasses and mosses.

However, the herbicide according to the invention is equally effective against all common weeds, including nettles, dandelions, dock weed, etc.

All of the active ingredients contained in the herbicide according to the invention are known to be poisonous to humans and other animals, if ingested. For example, laburnum seeds contain the toxic alkaloid cytisine.

However, all of the ingredients used in the herbicide according to the invention are obtained from naturally occurring plants found in many gardens, woods, etc worldwide.

The invention will be further illustrated by the following description with reference to the following Examples.

### EXAMPLE 1

Preparation of a Systemic, Broad-Spectrum Herbicide

A systemic, broad-spectrum herbicide was prepared from the following ingredients:

| Plant | Plant part | weight (g) |
|---|---|---|
| Rhubarb | leaf | 300 |
| Common yew | foliage + bark | 600 |
| Laburnum | leaf, bark + seeds | 300 |
| Black Bryony | roots + berries | 300 |
| Oxalic acid | | 150 |

Water (10 litres) was added as described below.

The various plant parts were shredded using a garden secateurs and/or a garden clipper, where necessary, and reduced to pieces of about 2.5 cm in size, and placed in a container. Sufficient water was added to cover the shredded plant material.

The mixture was then reduced to a pulp by pounding, using a metal weight mounted on a pole, and the remainder of the water added, when the desired consistency was achieved. The oxalic acid, manufactured by John Myland Ltd., of London, United Kingdom, and purchased from Lennox Chemicals, Dublin, was added with stirring until it dissolved. The resultant mixture had a yellow to green colour.

### EXAMPLE 2

Treatment of Bindweed with a Herbicide According to the Invention

A segment of bindweed, consisting of stem and leaves, from a growing plant was submerged in the mixture prepared in Example 1. Within 1-2 hours, the leaves showed pitting and developed brown spots. This pitting and development of brown spots was also observed on leaves which had not been submerged. After about 24 hours or more, the stem of the bindweed had turned brown and brittle. These results demonstrated that the herbicide of Example 1 was translocating within the plant, without the inclusion of a surfactant.

Separately submerging a segment of bindweed, consisting of stem and leaves, from a growing plant in filtered water had no effect, thereby establishing that the immersion in water was not responsible for the effects shown above, following submersion in the mixture prepared in Example 1.

### EXAMPLE 3

Treatment of Bindweed with a Herbicide According to the Invention

The mixture of Example 1 was applied to an area of ground infested with bindweed adjacent to one side of a yew hedge. The effects observed with immersion described in Example 2 were observed and the bindweed turned brown and died. Subsequently, there has been no evidence of re-emergence.

It was observed that an area of bindweed on the opposite side of the yew hedge to the side where the mixture had been applied and which did not appear to be connected to the bindweed treated with the mixture had also died. Thus, when a stem was treated on one side of the hedge the stem of a shoot on the other side became brittle, turned brown and dried up. This is further evidence that the herbicide according to the invention is acting systemically and translocating through the root system.

### EXAMPLE 4

An experiment was carried out to determine if plant extracts of rhubarb, yew and Black Bryony, as hereinbefore described, applied separately and at the same respective concentrations as used in the case of Example 1, would have the effect of eradicating weeds.

In each case, the plant extract was applied by brushing on the liquid to patches of ground covered with grass and moss. It was found that there was no effect when the plant extracts of rhubarb, yew and Black Bryony were applied individually. When a mixture of the rhubarb and yew was applied to an adjacent patch of ground covered with grass and moss, the patch turned brown and all of the vegetation died. A more rapid response was achieved with a mixture of rhubarb, yew and Black Bryony.

It was found that adding a small amount of Epsom salts to the herbicide, for example at a concentration of 40 g/litre, and which is known to stimulate growth of plants, appears to augment the effect of the herbicide according to the invention.

1.-16. canceled

17. A systemic, broad-spectrum herbicide comprising a water-soluble extract of plant parts of rhubarb and yew.

18. A systemic, broad-spectrum herbicide according to claim 17, wherein the plant part of rhubarb is the leaves.

19. A systemic, broad-spectrum herbicide according to claim 17, wherein the plant part of yew is a mixture of the bark and the foliage of the genus taxus.

20. A systemic, broad-spectrum herbicide according to claim 19, wherein the yew is common yew (Taxus baccata) or Japanese yew (Taxus cuspidata).

21. A systemic, broad-spectrum herbicide according to claim 17, containing one part rhubarb extract to two parts yew extract.

22. A systemic, broad-spectrum herbicide according to claim 17, which further contains a water-soluble extract of plant parts of the genus bryonia.

23. A systemic, broad-spectrum herbicide according to claim 22, wherein the plant part is from Black Bryony (Dioscorea communis).

24. A systemic, broad-spectrum herbicide according to claim 22, wherein the plant part is selected from at least one of the roots and the berries.

25. A systemic, broad-spectrum herbicide according to claim 17, containing a water-soluble extract of plant parts of the genus Fabaceae.

26. A systemic, broad-spectrum herbicide according to claim 25, wherein the plant part is from common laburnum.

27. A systemic, broad-spectrum herbicide according to claim 25, wherein the plant part is selected from at least one of bark, leaves, pods and seeds.

28. A systemic, broad-spectrum herbicide according to claim 17, which contains one part rhubarb extract to two parts yew extract, one part bryony extract and one part laburnum extract.

29. A systemic, broad-spectrum herbicide according to claim 17, wherein the rhubarb extract is supplemented with oxalic acid.

30. A systemic, broad-spectrum herbicide according to claim 17, applied topically to plants that are to be eradicated.

31. A systemic, broad-spectrum herbicide according to claim 30, applied by one of immersion, painting and spraying to an aerial part of a plant to be eradicated.

32. A systemic, broad-spectrum herbicide according to claim 30, wherein the plants to be eradicated are selected from bindweed, grasses and mosses.
